(19) United States
(12) Patent Application Publication
(10) Pub. No.: US 2006/0044183 A1
(43) Pub. Date: Mar. 2, 2006

(54) Low frequency radar antenna

(76) Inventor: Donald R. Wells, Long Beach, CA (US)

Correspondence Address: PATENT DOCKET ADMINISTRATION;RAYTHEON SYSTEMS COMPANY, P.O. BOX 902 (E1/E150), BLDG E1 M S E150, EL SEGUNDO, CA, 90245-0902, US

(21) Appl. No.: 10/929,177

(22) Filed: Aug. 30, 2004

(51) Int. Cl. G01S 13/66

(52) U.S. Cl. 342/148; 342/90; 342/95; 342/96

(57) ABSTRACT

A radar system comprises a plurality of radiator elements arranged in a vertical array. A feed system provides signals to the array at an operating frequency. The operating frequency is less than about 600 MHz.

### BACKGROUND OF THE DISCLOSURE

Ground-based surveillance radars typically use high gain, relatively high RF frequency (for example, X-band (approximately 3 cm) or S-band (approximately 10 cm)), pencil beam antennas to illuminate low-flying targets or targets close to the horizon. Such radars have less range than relatively lower frequency radars such as, for example, UHF (approximately ½ meter) or VHF (approximately 2 meters). Ground-based, low frequency radars, however, suffer a loss of signal at depression angles close to the horizon. This is due, at least in part, to multipath reflection and cancellation between the direct path signal from the antenna and reflections from the ground which can result in pattern nulls which can cause the loss of target signal or Adropping the track@. This phenomenon is relatively more severe in low frequency radars, for example, those with UHF or VHF frequencies which have a relatively larger elevation beam width and those for which the reflection coefficient from the ground is close to −1.

Ground-based, low frequency radars are used for long range surveillance, detection and tracking of high altitude targets because of their good signal level from airborne targets at long range. Because of problems associated with the loss of signal near the horizon, ground-based low frequency radars have been thought of as being unsuitable or unreliable for detecting, tracking or prosecuting low flying targets or targets near the horizon.

### BRIEF DESCRIPTION OF THE DRAWINGS

Features and advantages of the invention will readily be appreciated by persons skilled in the art from the following detailed description of exemplary embodiments thereof, as illustrated in the accompanying drawings, in which:

FIG. 1 is a block diagram of an exemplary embodiment of a radar system with a vertical aperture for illumination.

FIG. 1A is a illustrates an exemplary embodiment of an array of radiator elements.

FIG. 2 illustrates an exemplary far field pattern in free space for a radar system with an exemplary vertical aperture for illumination.

FIG. 3 illustrates exemplary pattern propagation factors of exemplary radar systems.

### DETAILED DESCRIPTION OF THE DISCLOSURE

In the following detailed description and in the several figures of the drawing, like elements are identified with like reference numerals.

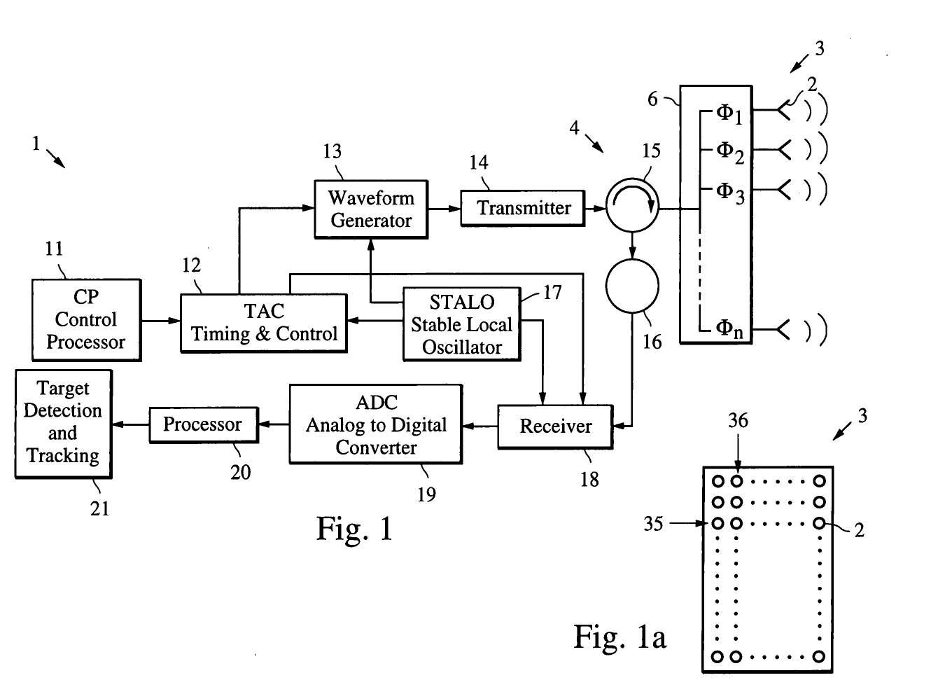

FIG. 1 illustrates a block diagram of an exemplary radar system 1. In an exemplary embodiment, the radar system 1 is a ground-based (based on land or water, for example, on a ship; not on an airborne platform) air surveillance system. The radar system 1 comprises a plurality of radiator elements 2 arranged in a vertical array 3. An antenna feed system 4 feeds the array with RF signals at an operating frequency and is configured to produce a vertical aperture of illumination. In an exemplary embodiment, the operating frequency is a relatively lower radar frequency such as those which might normally be used for long range detection and tracking. In an exemplary embodiment, the operating frequency may be, for example, UHF or VHF.

In an exemplary embodiment, the frequency is in the range of approximately 150 to 600 MHz.

In an exemplary embodiment, the radiator elements 2 can be individual feed horns, slots, dipoles and/or other appropriate radiator selected for use at the operating frequency. The array 3 may comprise, for example, from 20 to 50 rows of elements 2 arranged vertically. In an exemplary embodiment, the array 3 may have a vertical dimension of from 10 wavelengths to 25 wavelengths at an operating frequency. The radar system may have a wavelength of, for example, about one-half to about two meters.

In an exemplary embodiment shown in FIG. 1A, the array 3 comprises a two-dimensional array with a horizontal dimension to provide an azimuth width. In an exemplary embodiment, the array is wide enough to provide a finite azimuth beam which may provide for a finite scan time on a target, as the beam is scanned horizontally. In exemplary embodiments, the beam may be scanned horizontally either electronically or mechanically. The finite scan time on a target may allow a significant number of pulses to be placed on a target as the beam is scanned in azimuth, thereby improving target detection. In exemplary embodiments, the antenna may be scanned physically in azimuth by rotation or electronically by beam steering. A two-dimensional array 3 may be as wide as one half, one third or one fourth as wide as it is tall. In an exemplary embodiment, the radiator elements 2 are vertically and horizontally spaced about one-half of a wavelength at its operating frequency. In an exemplary embodiment a two-dimensional array comprises, for example, a planar array from about 20 to about 50 horizontal rows 35 and from about 15 to 25 vertical columns 36.

In an exemplary embodiment, the radar system 1 of FIG. 1 comprises a control processor 11, timing and control system 12, a waveform generator 13, a transmitter 14, a circulator 15, a transmit/receive protector 16, which may be, for example, a T/R tube, which may protect the receiver from high power when the transmitter is on. The exemplary radar system also comprises a stable local oscillator 17, a receiver 18, an analog to digital converter 19 and a signal processor 20.

In an exemplary embodiment, the antenna feed system 4 comprises a beam forming network 6, for example a corporate feed network. In the exemplary embodiment of FIG. 1, the beam forming network comprises a plurality of phase shifters 61 which feed the radiator elements 2 in the vertical array 3. Beam forming is the process by which each of the radiator signals are shifted in phase in order to affect the desired beam direction upon radiation from the antenna. This exemplary beam forming system is not the only beam forming system that could be employed, but is used here simply to illustrate one configuration that can be employed in this application.

In an exemplary active radar system 1, the beam forming on transmit and receive may be accomplished in both directions by a matrix of transmit amplifiers and receive amplifiers (not shown). The received signals are then processed in a processor 20 and combined to form a given beam direction, after which target detection and tracking 21 takes place. Signals in this exemplary embodiment are beam formed at the radiating RF frequency. The radiating frequency can be UHF, VHF or any frequency suitable for long range detection. The process can also be accomplished at intermediate frequencies and may be done this way in an active radar having transmit and receive amplifiers for each of the radiator elements.

In an exemplary embodiment, the vertical array 3 has a vertical aperture width to achieve the desired beam width of from about five to about ten degrees. The vertical beam width in radians is approximately equal to the ratio of the wavelength to the aperture length. In the exemplary embodiment of FIG. 1, the vertical array 3 comprises n radiator elements 2 spaced at one-half wavelength intervals at its operating frequency.

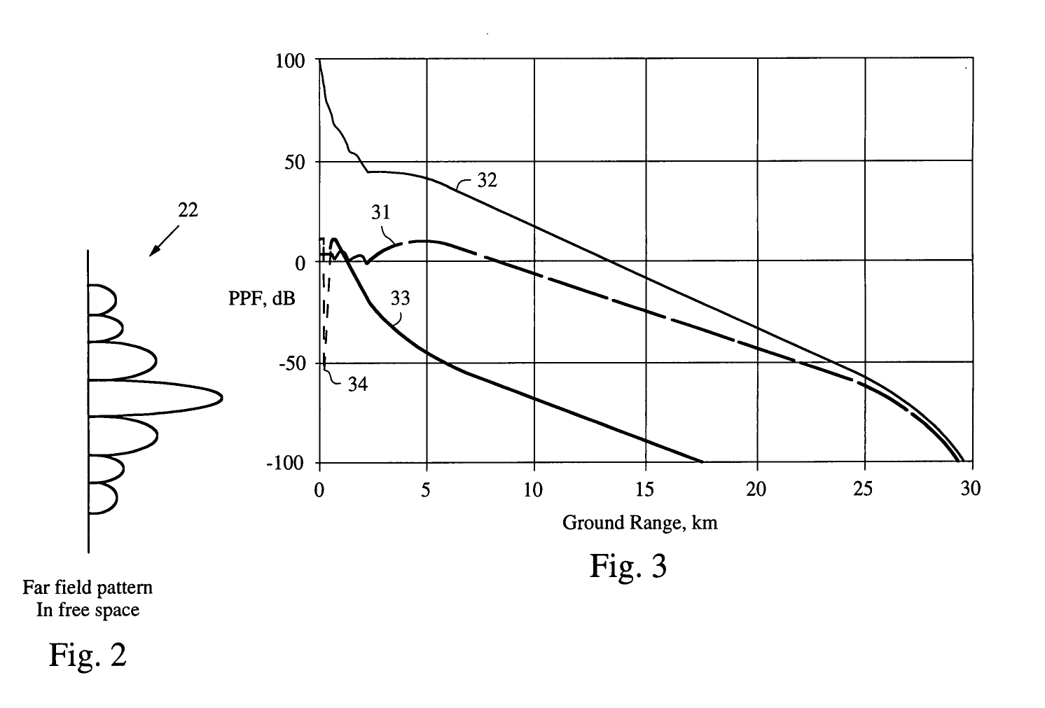

FIG. 2 illustrates a far field pattern 22 for an exemplary radar system. For a ground-based radar system, the PPF is the ratio of field intensity, taking into account ground reflections which influence the field strength in the presence of the ground, to the field strength of the radar in the absence of the earth, for example in free space. For a radar operated near the ground, the pattern of radiation resulting from the PPF has a null at the horizon and subsequent nulls and maxima in the elevation transmit and receive pattern. The PPF is a factor in the radar range equation which corrects the signal to account for the presence of the earth. The transmitted and received power is multiplied by the pattern propagation factor F. The radar range equation can be written in the form:
SNR={Pt Gt Gr RCS Lˆ2 Ft Fr}/{(4 Pi)ˆ3 Rˆ4 k Ts B Ls}, where:

SNR=signal to noise ratio per pulse

Pt=transmitted power per pulse

Gt=transmit antenna gain wrt isotropic

Gr=receive antenna gain wrt isotropic

RCS=target radar cross section

L=wavelength

Ft=pattern propagation factor for transmit

Fr=pattern propagation factor for receive

Pi=3.14159

R=target range

k=Boltzmann's constant

Ts=effective system temperature

B=bandwidth

Ls=system losses

In an exemplary embodiment, a low-frequency vertical array is suitable for long range detection and tracking and close-in tracking. The low-frequency antenna array can be used to track a low-flying incoming target from detection into close range without dropping the track at a null in the PPF curve that could otherwise occur with a discrete low frequency antenna. The antenna array may improve detection by enhancing the PPF and filling in nulls inherent in the PPF for discrete antennas as the target approaches the radar.

FIG. 3 illustrates exemplary PPF curves 31, 32 for a thirty-meter vertical array with a wavelength of about two meters for which the vertical phase center of the array is elevated to 35 meters above the ground. It also illustrates an exemplary PPF curve 33 for a discrete, single-element antenna elevated to 5 meters. For the exemplary PPF curves 31-33, the horizon is at about 30 km and the target is at an altitude of 200 m. Having a long, continuous vertical aperture of illumination fills in nulls that would otherwise occur in the PPF as a target approaches the radar. Such nulls could otherwise result in a temporary loss of target signal (Adropping the track@) throughout the target trajectory.

For example, in FIG. 3, the PPF curve 33 for a discrete, single-element antenna at 5 meter elevation has a null 34 at close range. The PPF curve 31 for a 30 meter vertical array at 35 meter elevation does not have a null at close range. The PPF curve 32 is for the same 30 meter vertical array at 35 meter elevation as for the curve 31, but multiplied by the increase in signal level relative to that from a target at 30 Km due to the fourth power law of range found in the radar range equation in the above formula.

In an exemplary embodiment, the vertical array 3 (FIG. 1) may be physically elevated. In an exemplary embodiment, the vertical array 3 (FIG. 1) is elevated above the ground so that the vertical phase center of the array is, for example, from about 15 to 25 wavelengths above the ground. For example, the phase center of a two-meter wavelength, 30 meter vertical array may be elevated to about 35 meters and the phase center of a ½ meter wavelength, 10 meter vertical array may be elevated to about 10 meters. Elevating the aperture of illumination increases the PPF above the PPF for a similar array at a lower elevation. The higher the antenna elevation, the larger the PPF. The theoretical average improvement for the PPF is about 6.41 dB against a low flying target as it approaches the radar. In an exemplary embodiment, a radar system 1 (FIG. 1) with a continuous vertical aperture may be located on a large capital ship or at an elevated antenna position or on a hillside location near a military installation, airport or other location from which it is desirable to detect targets close to the horizon.

In an exemplary embodiment, frequency diversity could alternatively be employed to fill in multipath nulls. In a further embodiment, frequency diversity is used in combination with a continuous vertical aperture to fill in multipath nulls. Either one or both could be used alone to produce improved results over discrete radiator low frequency radars. For example, at sufficient altitude and vertical aperture height, the PPF may be greater than 1.0 at a range of 10 km. Coupled with the increase in signal level due to the range raised the fourth power relative to a low-flying target near the horizon (for example a horizon range of 30 km), the combined effect may result in an increase in the received target signal out to a range of 15 km.

In an exemplary embodiment, the radar system 1 (FIG. 1) is configured to detect low, airborne targets and/or targets close to the horizon in addition to long-range surveillance and detection of high targets. In an exemplary embodiment, the system 1 can track a low level target at a range greater than could be tracked by a relatively higher frequency radar. Due to the reduction in multiple path nulls, an exemplary low-frequency radar system 1 can track a low flying target from acquisition at a distance of about 30 km throughout the track as it approaches the location of the antenna, with less likelihood of losing the track due to nulls at close range.

It is understood that the above-described embodiments are merely illustrative of the possible specific embodiments which may represent principles of the present invention. Other arrangements may readily be devised in accordance with these principles by those skilled in the art without departing from the scope and spirit of the invention.

What is claimed is:

1. A radar system comprising:
a plurality of radiator elements arranged in a vertical array;
a feed system for providing signals to the array at an operating frequency, wherein the operating frequency is less than about 600 MHz.

2. The radar system of claim 1, wherein the operating frequency is one of UHF, or VHF.

3. The radar system of claim 1, wherein the signals have wavelengths of about one-half meter or longer.

4. The radar system of claim 1, wherein the feed system is configured to provide a vertical aperture of illumination.

5. The radar system of claim 4, wherein the vertical aperture has a beam width in a range from about five degrees to about ten degrees.

6. The radar system of claim 1, wherein a vertical phase center of the array is elevated to a height of at least 15 wavelengths at the operating frequency.

7. The radar system of claim 1, wherein the vertical array comprises at least one column of radiator elements, wherein the column comprises at least twenty radiator elements.

8. The radar system of claim 1, wherein the array has a vertical dimension and a horizontal dimension of at least ¼ of the vertical dimension.

9. A ground-based air surveillance radar comprising:
a plurality of radiator elements arranged in a vertical array for transmitting RF signals;
a feed system for providing the RF signals to the array at an operating frequency, wherein the operating frequency is less than about 600 MHz;
a signal processor for processing return echos from the RF signals for detection and tracking of an airborne target.

10. The ground-based air surveillance radar of claim 9, wherein the operating frequency is one of UHF or VHF.

11. The ground-based air surveillance radar of claim 9, wherein the RF signals have wavelengths of about one-half meter or longer.

12. The ground-based air surveillance radar of claim 9, wherein the feed system is configured to provide a vertical aperture for illumination.

13. The ground-based air surveillance radar of claim 12, wherein the vertical aperture has a beam width in a range from about five degrees to about ten degrees.

14. The ground-based air surveillance radar of claim 9, wherein a vertical phase center of the array is elevated to a height of at least 15 wavelengths at the operating frequency.

15. The ground-based air surveillance radar of claim 9, wherein the vertical array comprises at least twenty rows of radiator elements.

16. The ground-based air surveillance radar of claim 9, wherein the array has a vertical dimension and a horizontal dimension of at least ¼ of the vertical dimension.

17. A ground-based radar system comprising:
a plurality of low-frequency radiator elements arranged in a two-dimensional array;
a feed system comprising a beam forming network and configured to provide a vertical aperture of illumination at an operating frequency of less than about 600 MHz for low-altitude air search and tracking.

18. The ground-based radar system of claim 17, wherein the vertical aperture has a beam width in a range from about five degrees to about ten degrees.

19. The ground-based radar system of claim 17, wherein a vertical phase center of the array is elevated to a height equal to at least 15 wavelengths at the operating frequency.

20. A method of operating a radar system, comprising:
providing a vertical array of radiator elements;
transmitting a radar signal from the vertical array at an operating frequency of less than about 600 MHz;
receiving a return echo from an airborne target at a radar receiver;
determining a location of the airborne target responsive to the return echo.

21. The method of claim 20, wherein transmitting a radar signal comprises providing a vertical aperture of illumination.

22. The method of claim 21, wherein the vertical aperture has a beam width in a range from about five degrees to about ten degrees.

23. The method of claim 20, wherein the target is at an altitude of less than 200 meters.

24. The method of claim 20, further comprising tracking the airborne target from a first determined location at a distance of greater than 15 km.

25. The method of claim 24, further comprising tracking the airborne target from the first determined location to the vertical array without experiencing a PPF null due to multipath reflections.

26. A ground or water based air surveillance system comprising:
a plurality of radiator elements arranged in a two-dimensional array, wherein the array has a vertical dimension and a horizontal dimension of at least one quarter of the vertical dimension, and wherein the array comprises at least one column of radiator elements and the column comprises at least twenty radiator elements;
a feed system for providing signals to the array at an operating frequency, wherein the feed system is configured to provide a vertical aperture with a beam width in a range from about five degrees to about ten degrees, and wherein the operating frequency is less than about 600 MHz;
wherein a vertical phase center of the array is elevated to a height in a range from 15 to 25 wavelengths at the operating frequency.
